(19) United States
(12) Patent Application Publication
(10) Pub. No.: US 2005/0253906 A1
(43) Pub. Date: Nov. 17, 2005

(54) Bulk ink feed system for inkjet printer

(76) Inventors: Timothy R. McGrath, Lynnwood, WA (US); Patrick T. Moore, Mountlake Terrace, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/843,023

(22) Filed: May 11, 2004

(51) Int. Cl. B41J 2/175

(52) U.S. Cl. 347/85

(57) ABSTRACT

A bulk ink feed system for an inkjet printer comprising a plurality of reservoirs coupled by a plurality of conduits through a plurality of inlet connectors on an ink cartridge carrier of an inkjet printer. The plurality of conduits contain an accumulator section adjacent the coupler. The accumulator section has a larger volume than the remainder of the conduit, which inhibits the reverse flow of ink from the accumulator section toward the reservoir section when the inkjet printer is not in use.

### FIELD OF THE INVENTION

The present invention relates to ink feed systems for inkjet printers, more particularly, to a bulk ink feed system, and most particularly, to an after-market add-on bulk feed system for inkjet printers.

### BACKGROUND OF THE INVENTION

Modern inkjet printers are capable of high resolution printing of graphics. This is made possible by inkjet printers that have droplet sizes on the order of one to four picoliters. Very high resolution graphics and especially photographs, can be printed in multiple copies; however, photographs particularly require large quantities of ink. As a result, conventional cartridges utilized with inkjet printers are consumed relatively quickly. Because these cartridges are expensive, production use of inkjet printers to print repetitive graphics becomes costly.

Bulk feed systems have thus been devised for use with inkjet printers. However, because of the proprietary electronics employed in the printers and because of difficulties in obtaining proper ink feed, these systems have marginal utility. For example, one problem with prior attempts to provide bulk feed systems is that once a graphic is printed and the printer is stopped, the ink tends to drain back to the reservoir. One means for solving this problem is to raise the reservoirs above the level of the ink cartridge; however, this tends to feed too much ink to the ink cartridge causing leakage and low quality output.

### SUMMARY OF THE INVENTION

The present invention provides a unique bulk feed system that utilizes the existing ink cartridge carriers in conventional inkjet printers. Conventional cartridges are modified to expose the ink feed fittings in the cartridge carrier. The modified ink cartridges are electronically reset to indicate the cartridge is full. In this context, applicant's ink feed system is designed for use with an inkjet printer, including a cartridge carrier, which carrier has an ink connection section and an electronic connection section. The ink connection section includes a plurality of inkjet couplers for receiving ink. The bulk feed system comprises a plurality of reservoirs for holding ink. A plurality of conduits are placed in fluid communication between the reservoirs and the corresponding ones of the couplers. Each conduit comprises a first portion having a first inside diameter. The first portion extends from a reservoir to adjacent an ink coupler. The remainder of the conduit comprises a relatively short accumulator section coupled between the first portion and the coupler. Preferably, the accumulator section comprises a larger diameter conduit than the first portion of the conduit. Finally, a modified cartridge is configured to expose the couplers and is adapted for connection to the electronic section of the carriage.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is an isometric view of a conventional inkjet printer having a cartridge carrier using the bulk ink feed system of the present invention;

FIG. 2 is an exploded view of the cartridge carrier and portions of applicant's bulk ink feed system;

FIG. 3 is a cross-sectional view of the cartridge carrier showing a modified cartridge and a conduit coupled to an ink coupler on the carrier;

FIG. 4 is an isometric view of a modified cartridge in accordance with the present invention; and

FIG. 5 is an isometric view of an assembled carrier with modified cartridges and at least one conduit in place.

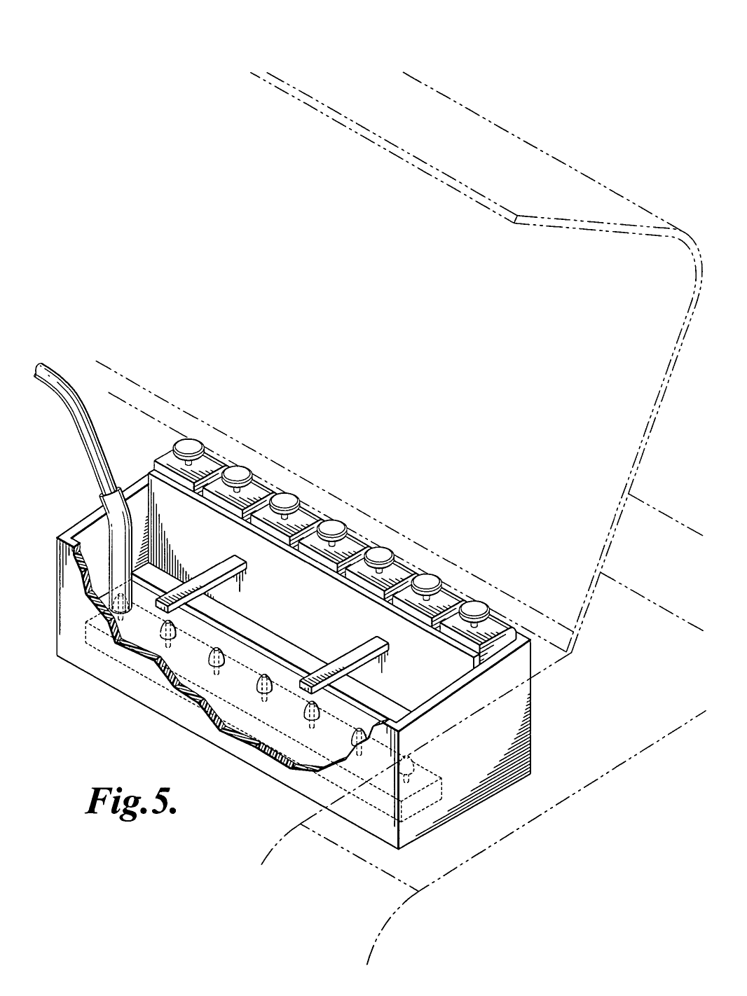

### DETAILED DESCRIPTION OF THE PREFERRED EMBODIMENT

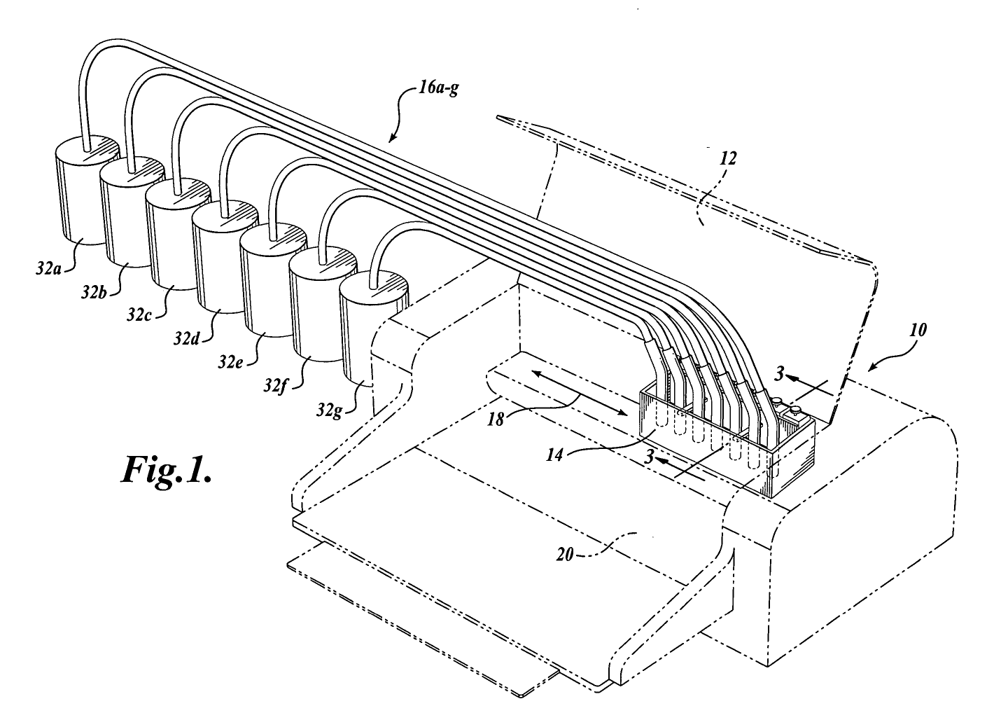

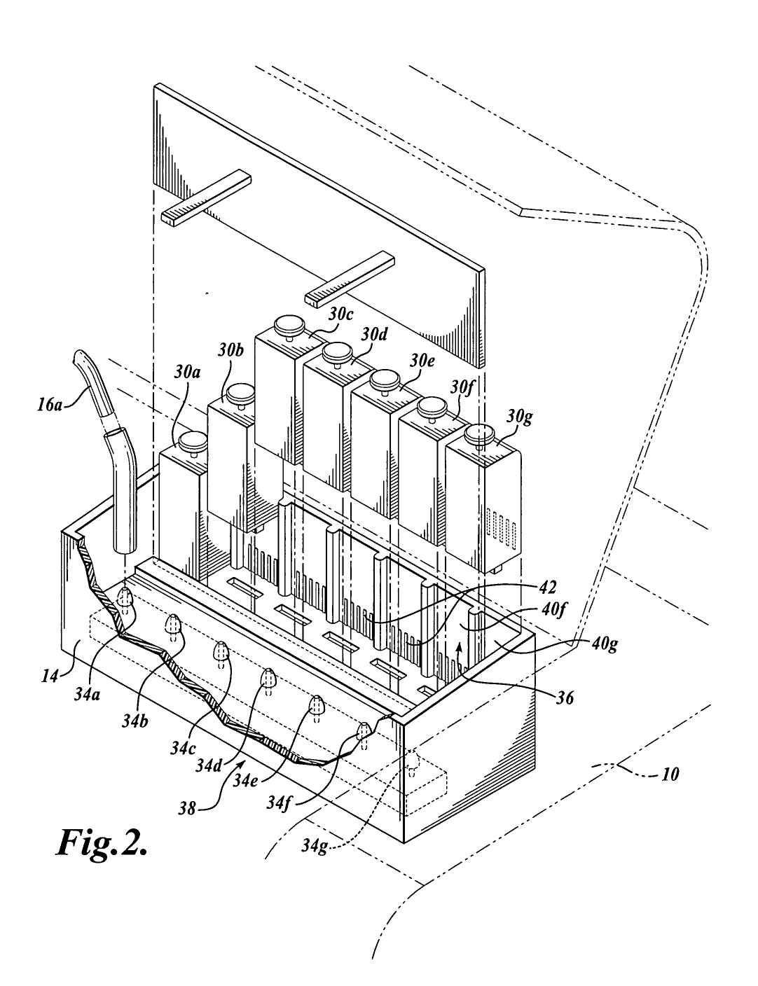

Referring to FIG. 1, an inkjet printer 10 is shown in phantom outline. The lid 12 that covers the cartridge carrier 14 is shown in an open position. It is preferred, however, in the context of the present invention that the lid 12 be removed and that all of the area above the cartridge carrier 14 be open so that movement of the ink supply conduits 16a-16g can occur unimpeded as the carrier moves back and forth in the direction of arrow 18 over paper 20 being fed through the inkjet printer 10. Referring to FIGS. 1, 2, and 3, the inkjet cartridge carrier 14 is unmodified from the original equipment. A plurality of modified ink cartridges 30a-30g are inserted in the cartridge carrier 14. A plurality of ink reservoirs 32a-32g are positioned on the support surface for the inkjet printer 10 adjacent to one side of the printer. A plurality of supply conduits 16a-16g connect the individual reservoirs 32a-32g to individual ink couplings 34a-34g normally located on the bottom of the cartridge carrier 14. A plurality of conduits 16a-16g are shown in FIG. 1 while only one 16a is shown in FIG. 2 for clarity.

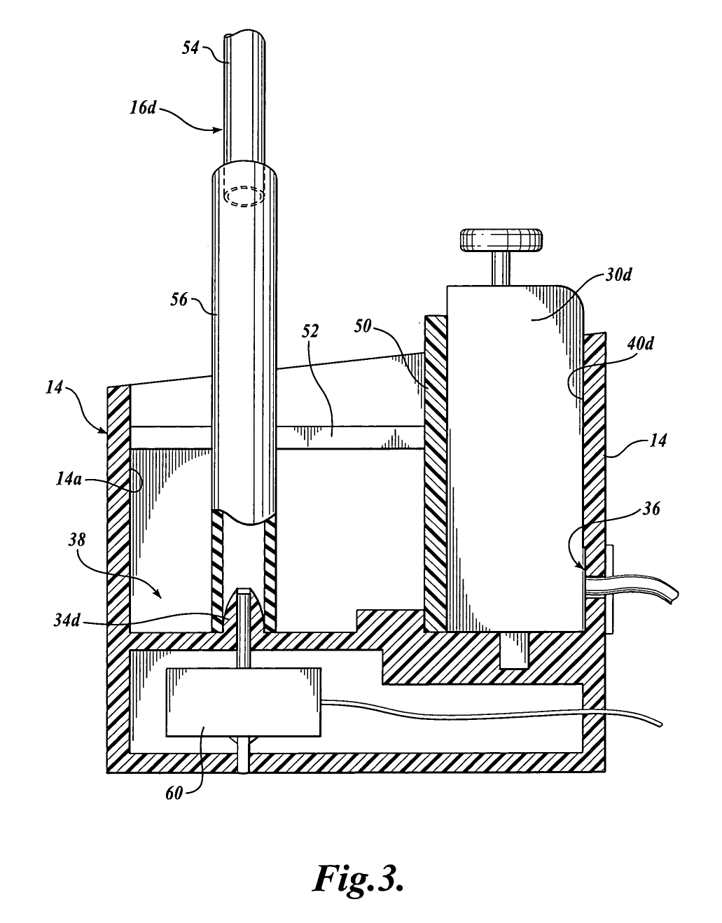

Referring now to FIGS. 2 and 3, the cartridge carrier 14 is unmodified from its original equipment. It has in its right-hand section an electronic connection section 36 and on its left side an ink connection section 38. The electronic connection section 36 has a plurality of receptacles 40a-40g for receiving the right-hand side of a conventional ink cartridge. Each of the receptacles 40a-40g in the electronic connection section 36 carries a plurality of contacts 42 on the inside thereof. In the embodiment shown, seven receptacles 40a-40g are shown. Conventionally, this cartridge carrier would normally carry seven conventional inkjet cartridges, the right-hand portions of which would fit in the electrical connection side and the left-hand portions would fit in the ink connection side. Each cartridge would have a right-hand side having contacts thereon that would make electrical contact with the contacts 42 on the carrier to provide information to the inkjet printer while the remainder of the conventional cartridge would contain an integral ink reservoir that would fit over the respective ink couplings 34a-34g.

In the modified version in accordance with applicant's invention, the conventional cartridges are modified by removing the integral ink reservoir and leaving only an electronic connection side as the modified cartridges 30a-30g. These modified cartridges 30a-30g contain the original electronics which, among other things, communicate to the inkjet printer when the integral reservoir is empty or full. The modified cartridges 30a-30g may, when modified, have their internal setting indicating that the cartridge is empty. These cartridges can be reset with commercially available hardware, for example, a cartridge resetter for Epson ink cartridges is sold under the trade name JY 168-II, and are available from suppliers such as InkJetCartridges.Com, having an address at 99 Fifth Avenue, Suite 191, Ottawa, Ontario KIS 5P5, Canada.

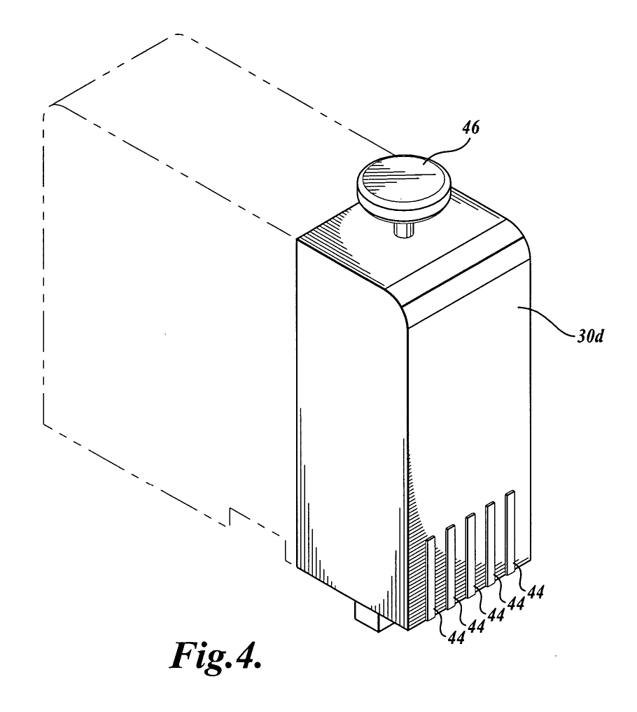

It is necessary that these modified cartridges 30a-30g be in place in the carriage 14 in accordance with applicant's invention so that the inkjet printer believes that a conventional cartridge is in place. Referring to FIG. 4, a selected cartridge 30d has electrical contacts 44 which correspond to the contacts 42 on the cartridge carrier 14. The modified cartridges 30a-30g have also been provided with a handle 46 with which the modified cartridges can easily be moved. The modified cartridges 30a-30g fit in the receptacles 40a-40g and are secured thereto by an internal wall 50 that abuts against the left-hand side of each of the cartridges 30a-30g. The wall 50 is held in place by arms 52 that extend between the wall 50 and the left-hand wall 14a of the cartridge carrier 14. Thus, the modified cartridges 30a-30g are held in place so that the contacts thereon can be secured in electrical contact with contacts 42 in the cartridge carrier.

Each of the conduits 16a-16g extending from the reservoirs 32a-32g to the couplings 34a-34g in the carrier 14 comprise an elongated tubular section 54 having a first diameter and a shortened tubular section 56 having a second internal diameter (the accumulator section). Each of the second tubular sections 56 is sized to fit over the ink couplings 34a-34g in an interference fit so that the tubular section 56 is in secure attachment to the coupling. The second tubular section 56, because of its larger internal diameter, functions as an accumulator for ink immediately prior to the couplings 34a-34g. In this manner, the ink can be supplied to the inkjet mechanism 60 forming an integral part of the cartridge carrier 14 in a continuous manner. In addition, when the inkjet mechanism 60 is not calling for ink, because of the increased volume of ink in the enlarged tubular section (accumulator) 56, the ink will tend not to siphon back into the reservoirs 32a-32g, even when the inkjet printer is unused for a long period of time.

In a most preferred embodiment, the enlarged tubular sections 56 have an inside diameter of 1/8th of an inch and an outside diameter of ¼ of an inch. The tube running from the accumulator 56 to the reservoirs preferably has an inside diameter of a 1/16th of an inch with an outside diameter of 1/8th of an inch. The relative dimensions of the accumulator tube, however, can be varied from about 150% to 300% of the diameter of the smaller tube 54. It is preferred, however, that it be about twice the diameter, that is, 200% of the diameter of the smaller tube. The accumulator can also be from one to six inches long, preferably from three to five inches long, and most preferably, about four inches long.

In practice, the ink can be continuously supplied to the cartridge carrier 14 from the reservoirs 32a-32g through the conduits 16a-16g. When it becomes necessary to replenish ink, the reservoirs 32a-32g need only be filled. The supply of ink in the tubes 16a-16g need not be disturbed at any time once initially primed.

Thus, in accordance with applicant's invention, the inkjet printer 10 can be continuously supplied with ink from the reservoirs 32a-32g. Thus, the inkjet printer can continuously function throughout its lifetime without the necessity of replacing ink cartridges.

While the preferred embodiment of the invention has been illustrated and described, it will be appreciated that various changes can be made therein without departing from the spirit and scope of the invention.

1. A bulk ink feed system for an inkjet printer, said printer including a cartridge carrier, said carrier having an ink connection section and an electronic connection section, said ink connection section including a plurality of inkjet couplers for receiving ink, said bulk feed system comprising:
a plurality of reservoirs for holding ink;
a plurality of conduits in fluid communication between said reservoirs and corresponding ones of said couplers, said conduit comprising a first portion having a first inside diameter extending from said reservoir to adjacent said connector, and a relatively short accumulator section coupled between said first portion and said coupler, and a cartridge configured to expose said couplers for connection to the electronic section of said connector.

2. The system of claim 1, wherein said accumulator section of said conduit has a larger inside diameter than said first portion.

3. The system of claim 2, wherein said larger diameter is from 150% to 300% greater than said first diameter.

4. The system of claim 3, wherein said larger diameter is about 200% greater than said first diameter.

5. The system of claim 2, wherein said larger diameter section is from one to six inches long.

6. The system of claim 5, wherein said larger diameter section is from three to five inches long.

7. The system of claim 1, wherein said cartridge is configured to indicate that the ink reservoir associated with it is full.
